(19) United States
(12) Patent Application Publication
(10) Pub. No.: US 2007/0146311 A1
(43) Pub. Date: Jun. 28, 2007

(54) Roller with single piece carriage and open front hook

(75) Inventors: Feng-Hao Lin, Hsin-Chu (TW); Chi-ming Wang, Hsin-Dien (TW); Tzu-Ching Chu, Taoyuan (TW); Tsung Hsin Hsieh, Luzhu Shiang (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/317,861

(22) Filed: Dec. 22, 2005

(51) Int. Cl. G09G 5/00

(52) U.S. Cl. 345/156

(57) ABSTRACT

A roller apparatus for a computer input device, such as a mouse, that has a sturdier support than prior art supports. A scrolling wheel carriage is supported by a PCB for greater stability. An open hook support for the hinge of a wheel carriage angles outward below a retaining point for the hinge. This combines with the hinge being hollowed out, so that upward forces due to variations in PCB thickness cause the hinge to compress while retained by the hook support. The design also provides long side arms for activating microswitches for lateral scrolling, and stoppers for preventing forward and backward slippage.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to scroll wheels for mice and other input devices.

Examples of controllers configured to control scrolling of graphical objects include the controllers discussed in U.S. Pat. No. 5,446,481, filed Aug. 29, 1995, titled “Multidimensional Hybrid Mouse for Computers,” owned by Mouse System Corporation, and in Patent Abstract of Japan, Publication No. 2002-366300, titled Mouse With Scroll Functions, owned by Toshiba Corp.

Microsoft published U.S. Application No. 2003/0025673 shows a mouse with a wheel that is tiltable in a carriage and assembly carrier structure to provide horizontal scrolling in addition to the vertical scrolling from rotation of the wheel. This published application claims priority from published U.S. Application No. 2002/0158844 that shows a scrolling wheel that slides laterally to provide for horizontal scrolling.

Gillick U.S. Pat. No. 5,446,481 shows a roller on a mouse that can be tilted to activate Z axis inputs. A number of other approaches have been taken to provide horizontal or a similar type of scrolling.

FIGS. 1A-C are diagrams of a prior art Microsoft roller design used in the Microsoft Wireless Notebook Optical Mouse 4000. FIG. 1A shows the wheel and carriage mounted on the bottom case. FIGS. 1B and 1C show the wheel carriage and bottom case separately. A scroll wheel 10 is mounted in a single piece plastic carriage 12. A front hinge 14 of the carriage is supported by an open hook support 16, while a back hinge 18 is supported by a second open hook support 20. An downward extending arm 22, integrally formed with back hinge 18, contacts microswitches 24 and 26 when the wheel is tilted side-to-side. The front end of the wheel carriage 12 tilts downward when the wheel is pressed by a user, activating microswitch 28. A spring 30 biases the wheel carriage upward.

The front and back open hooks 16 and 20 are wide, but narrow, with the wide dimension resisting lateral movement of the wheel and carriage assembly. Stops 32 and 34 on the bottom of the carriage 12, as seen in FIG. 1B, stop forward and backward movement by contact with the side of the microswitch 28 and back open hook support 20.

FIGS. 2A-B show a prior Logitech design. A single piece wheel carriage 40 has a front hinge 42 which engages a hole 44. A pair of lateral extending arms 46 and 48 contact microswitches when the wheel is pushed laterally. The center of the microswitch is 7.9 mm in the lateral direction from a line 54 running through the center of the wheel, and 9.8 mm forward of a center point 56 of the wheel. Sometimes, lateral pressure can be inadvertently applied, activating the microswitches when it is not desired.

### BRIEF SUMMARY OF THE INVENTION

The present invention provides a roller apparatus for a computer input device, such as a mouse, that has a sturdier support than prior art supports. An open hook support for the hinge of a wheel carriage angles outward below a retaining point for the hinge. This combines with the hinge being hollowed out, so that upward forces cause the hinge to compress while retained by the hook support. For example, routine variations in PCB thickness will not cause the hinge to pop out or become stuck with this design.

In one embodiment, the front hinge also has widened portions on either side of the hook support to prevent forward and backward movement of the wheel carriage. Additionally, the wheel carriage includes a vertical wall at a back side wheel for engaging a stopper extending downward from a top case of the input device, to restrain backward movement. This allows two front arc strip stoppers on the wheel carriage hinge to be very small protrusions, only enough to keep the carriage in place on the production assembly line.

In one embodiment, lateral extending arms on the wheel carriage engage microswitches when the wheel carriage is tilted due to sideways pressure. This provides a horizontal scrolling function. Prior art designs have proven to be too sensitive to inadvertent lateral movement. This embodiment of the invention lengthens the arms, thus lengthening their moment arm and reducing the sensitivity to inadvertent lateral pressure. The switch is also moved forward a little. The PCB edge is the supporting point, a non-moving point. When the user tries to press the rear switch, the portion of the wheel carriage not moving vertically is at the PCB edge. The more rearward the arm location, the more the arm can move. By moving the switch forward, this also helps to decrease the sensitivity, avoiding inadvertent horizontal scrolling when trying to click the roller.

For a further understanding of the nature and advantages of the invention, reference should be made to the following description taken in conjunction with the accompanying drawings.

### BRIEF DESCRIPTION OF THE DRAWINGS

FIGS. 1A-1C are diagrams of a prior art Microsoft wheel carriage design.

FIGS. 2A-2B are diagrams of a prior art Logitech wheel carriage design.

FIG. 3 is a perspective view of a wheel carriage design mounted in a mouse according to an embodiment of the present invention.

FIG. 4 is a side view of the wheel carriage of FIG. 3 showing the mounting on a PCB.

FIG. 5 is a perspective view of the wheel carriage alone of FIG. 3.

FIG. 6 is a perspective view of the underside of a mouse cover including a stopper according to an embodiment of the invention.

FIG. 7 is a diagram of the front view of the open hook support of FIG. 3.

### DETAILED DESCRIPTION OF THE INVENTION

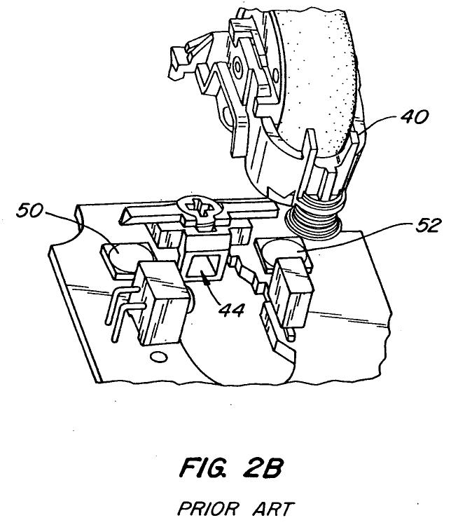

FIG. 3 shows a wheel 60 and wheel carriage 62 mounted in a mouse bottom case 64 according to an embodiment of the present invention. A ratchet spring 66 engages detents inside wheel 60. A front hinge 68 is integrally formed with wheel carriage 62, which is a single piece of plastic. Hinge 68 has a hollowed out center 70. The hinge is supported by an open hook support 72, shown in more detail in FIG. 7. As in the prior art, the wheel can be rotated to provide scrolling or other Z direction input signals. The wheel can also be tilted sideways to provide horizontal scrolling or an additional X direction input.

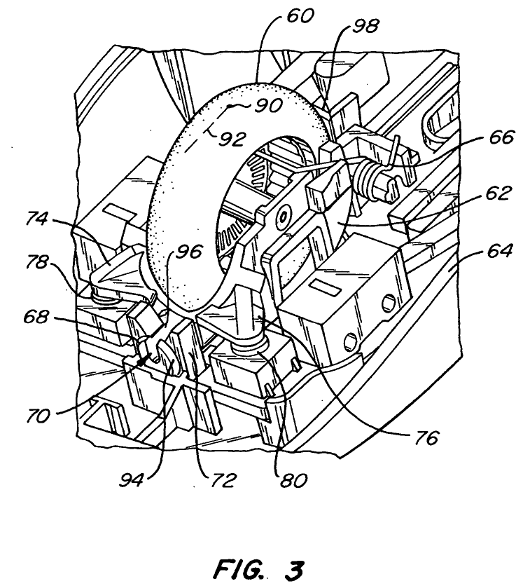

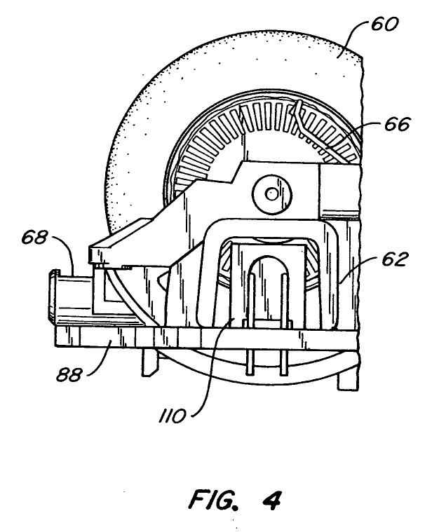

The side view of FIG. 4 shows that wheel carriage 62 is supported by a printed circuit board (PCB) 88. By resting the wheel carriage on the PCB, the PCB can help absorb the shock if the mouse is dropped, by distributing the forces throughout the length and breadth of the PCB. The PCB also restrains the bottom of open hook support 68, providing greater stability. However, the variations in thickness of the PCB can cause problems, popping the wheel carriage out of its support with upward pressure, or impacting the tilting ability of the wheel carriage for horizontal scrolling. The hollowed portion 70 of hinge 68 allows it to compress, rather than pop out, in response to upward pressure from the PCB. As seen in the side view of FIG. 7, open hook support 72 has a first inward sloping surface 82 allowing easy assembly by pushing the hinge down until it is secured below an outward and downward sloping surface 84. Surface 84 acts to restrain the hinge as it is pushed upward by a thick PCB, avoiding the popping-out problem.

Returning to FIG. 3, arms 74 and 76 extend farther sideways and forward than the prior art Logitech design. This gives a longer moment arm, requiring more force for lateral scrolling and avoiding most inadvertent lateral scrolling. In addition, this allows larger, and thus cheaper, switches 78 and 80 to be used. Switches 78 and 80 can be dip type switches of the type that are assembled manually. The manual assembly process is cheaper than machine assembly, which uses SMD type components. Thus, the design of the invention allows a bigger, cheaper switch to be used. The arms are 11.9 mm in front of a center point 90 of the wheel, and 9.0 mm to the side (laterally) of center line 92. This is 2.1 mm and 1.1 mm longer than the prior art Logitech design.

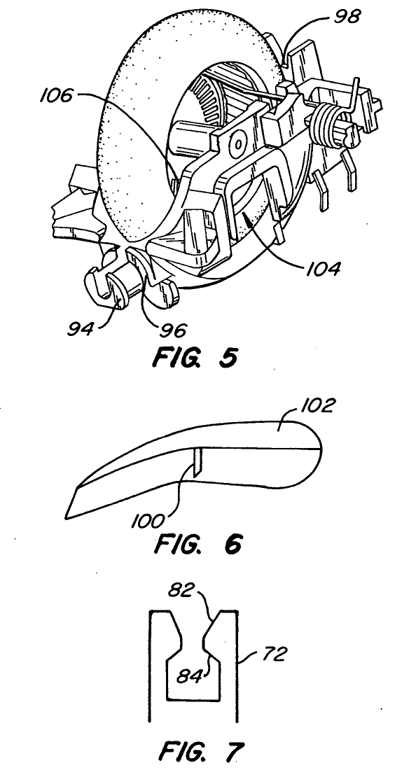

Hinge 68 includes disk-shaped stoppers 94 and 96 to prevent forward and backward movement of the wheel carriage. These can be better seen in the view of FIG. 5. Additionally, a vertical wall 98 at the back of wheel carriage 62 is a stopper which contacts a member 100 which descends from the mouse top cover 102 as shown in FIG. 6.

Open hook support68 is wider than prior art supports in the direction parallel to the wheel. This provides more strength in this direction, enabling it to resist forward and backward pressures on the wheel carriage, which cause stoppers 94 and 96 to press against support 68.

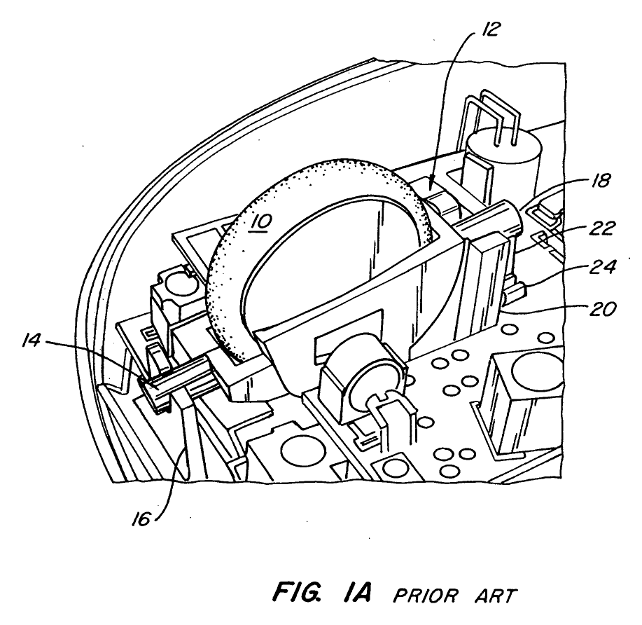

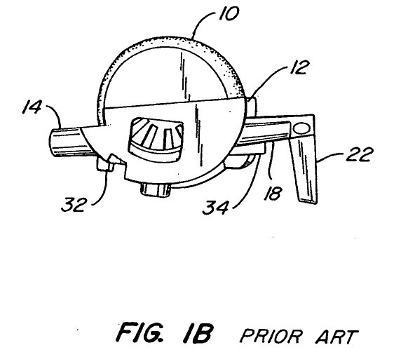

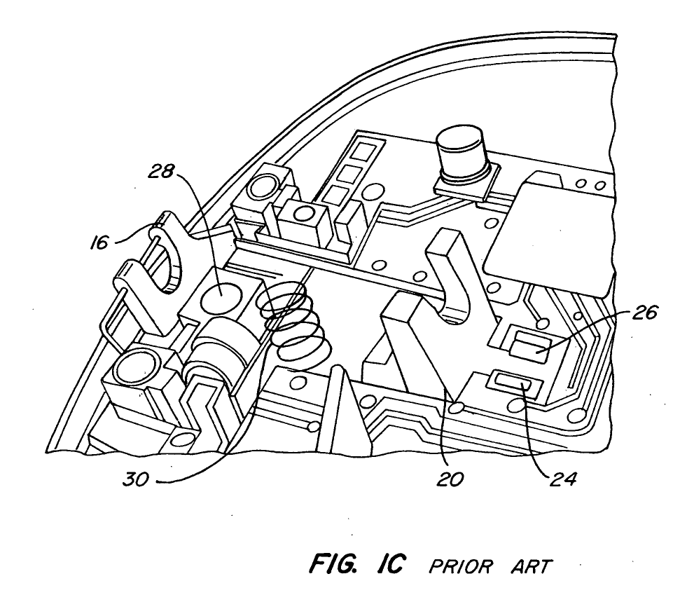

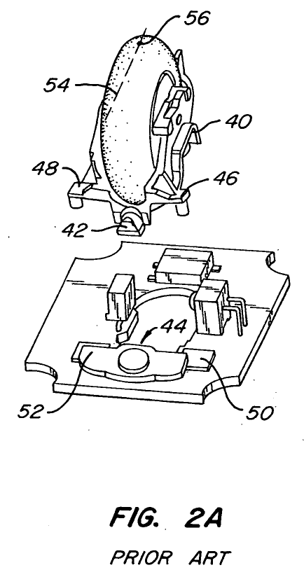

As best seen in FIG. 5, a gap 104 in the wheel carriage allows a standard optical encoder to pass light through slots 106 in the wheel. FIG. 4 shows an LED 104 which shines light to a photodetector on the other side of the slots in the wheel. Alternately, a mechanical encoder could be used. A sustain coil spring is mounted below the wheel carriage to provide an upward force, similar to the springs visible in FIGS. 1C and 2B. A microswitch [not shown] is mounted below the wheel carriage as in the prior art, to allow depression of the wheel carriage to activate the microswitch. It is mounted toward the back of the wheel carriage to allow the back part of the wheel carriage to depress, pivoting downward from hinge 68, which does not depress The open hook support and the PCB together form a hinge. The hook support stops the wheel carriage from moving left, right and up. The PCB stops the carriage from moving downward. The PCB also helps keep the hook from opening.

The design of the wheel carriage assembly according to the present invention provides a number of advantages. The module contains only 4 main parts: wheel, wheel carriage, ratchet coil spring and sustain coil spring. The front hook design fixes support on the PCB and tolerates thickness differences in PCBs. The open hook support allows simple assembly. The stoppers enhance the performance of the mouse in drop tests.

As will be understood by those of skill in the art, the present invention may be embodied in other specific forms without departing from the essential characteristics thereof. For example, the wheel carriage could be mounted in a trackball, keyboard, remote control, gamepad, or other computer input device. A tact switch (switch with round actuator) is used for the horizontal scrolling, and a microswitch for the roller clicking by depressing function. However, other combinations could be used. Accordingly, the foregoing description is intended to be illustrative, but not limiting, of the scope of the invention which is set forth in the following claims.

What is claimed is:

1. A roller apparatus for a computer input device, comprising:
a scrolling wheel;
a single piece wheel carriage supporting said wheel, said carriage having a front hinge;
an open hook support for engaging said front hinge, said open hook support having opposing sides angled inward from the top to a retaining point, forming a slot; said opposing sides angling outward below said retaining point, such that a downward retaining force is applied to said hinge, said hinge being supported below said retaining point;
a printed circuit board having a portion mounted immediately below said front hinge of said wheel carriage;
said front hinge of said wheel carriage being hollowed out so that said hinge can compress in response to upward forces from a thicker printed circuit board without popping out of said open hook support.

2. The apparatus of claim 1 wherein said front hinge has a first widened portion on a far side of said hinge from said wheel carriage, to engage a far side of said open hook support, to prevent backward slippage of said hinge.

3. The apparatus of claim 2 wherein said front hinge further has a second widened portion on a near side of said hinge from said wheel carriage, to engage a close side of said open hook support, to prevent forward slippage of said hinge.

4. The apparatus of claim 1 wherein said wheel carriage further comprises a vertical wall at a back side of said wheel for engaging a stopper extending downward from a top case of said input device.

5. The apparatus of claim 1 wherein said open hook support has a thickness of a least ¼ of its width.

6. The apparatus of claim 1 further comprising a pair of arms extending laterally from a front portion of said wheel carriage to activate microswitches for indicating lateral tilting of said wheel, each of said microswitches having a center point mounted at least 11.5 mm frontward from a center of said wheel and at least 8.5 mm laterally outward from a line through said center of said wheel.

7. A roller apparatus for a computer input device, comprising:
a scrolling wheel;
a single piece wheel carriage supporting said wheel, said carriage having a front hinge;
an open hook support for engaging said front hinge, said open hook support having opposing sides angled inward from the top to a retaining point, forming a slot; said opposing sides angling outward below said retaining point, such that a downward retaining force is applied to said hinge, said hinge being supported below said retaining point;
a printed circuit board having a portion mounted immediately below said front hinge of said wheel carriage;
said front hinge of said wheel carriage being hollowed out so that said hinge can compress in response to upward forces from a thicker printed circuit board without popping out of said open hook support;
wherein said front hinge has a first widened portion on a far side of said hinge from said wheel carriage, to engage a far side of said open hook support, to prevent backward slippage of said hinge, and a second widened portion on a near side of said hinge from said wheel carriage, to engage a close side of said open hook support, to prevent forward slippage of said hinge; and
wherein said wheel carriage further comprises a vertical wall at a back side of said wheel for engaging a stopper extending downward from a top case of said input device.
